(19) United States
(12) Patent Application Publication
(10) Pub. No.: US 2007/0237135 A1
(43) Pub. Date: Oct. 11, 2007

(54) Method and Apparatus for Routing Communications

(76) Inventors: Nicholas Mark Trevallyn-Jones, Epping (AU); Merdith Anne Trevallyn-Jones, Cremorne (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/628,789

(22) PCT Filed: Jun. 7, 2005
(86) PCT No.: PCT/AU05/00816

§ 371 Date: Dec. 6, 2006

(30) Foreign Application Priority Data
Jun. 7, 2004 (AU) 2004903034

(51) Int. Cl. H04L 12/66

(52) U.S. Cl. 370/354

(57) ABSTRACT

A communication, such as a telephonic or data communication, is routed between an initiator (1) and a recipient (5) based on the preferences of the initiator, or of both the initiator and the recipient. A virtual end-point (61,66) is allocated for each user (1,5). Each virtual end-point (61,66) stores one or more end-points for the respective user, typically as address/protocol pairs representing the addresses of the user's communication devices. The virtual end-points (61,66) are stored in a data store (60) accessible by a gateway (100) which communicates with the network(s) (80,85) with which the communication devices (2,6) of the initiator and recipient communicate. Preferences are associated with each virtual end-point, and specify the categories of protocols to which the end-points of that virtual end-point belong. The preferences may specify which of the end-points of the respective virtual end-point to use for a communication routing path when certain criteria are met. A routing engine (30) in the gateway (100) determines a routing path between an initiator end-point (82) and a recipient end-point (86), for example by rules-based processing, in accordance with the preferences associated with the virtual end-points for the initiator and the recipient. The gateway (100) also converts the protocol or format of the communication from that of the initiator's end-point to that of the recipient's end-point, if required.

### TECHNICAL FIELD OF THE INVENTION

This invention relates to a method and apparatus for routing communications, particularly telephonic and data communications, when there may be a plurality of possible end-points for the initiator and/or recipient, and the protocol for the initiator and recipient may differ.

### BACKGROUND OF THE INVENTION

Communication networks, such as telephone networks and data networks are used to carry various types of telephonic and data communications. Often communication networks are interconnected with other communication networks. Various different protocols are used for communication on these networks, each defining how the end-points of the communication are described and located, and the form the communication must take so that it is acceptable and understandable by both parties. For example, an email protocol defines how email addresses are resolved to actual email in-trays and how email messages are packaged, transported and delivered; and a telephone protocol defines how telephone numbers are resolved to actual telephones and how a telephone connection is established and audio information transported. (The term ‘resolve’ is used in the art to mean, in relation to addresses, interpreting the address to determine the actual location for delivery.)

For a given protocol, each end-point is defined as an address/protocol pair, which inherently means users cannot address an end-point without knowing the protocol and it is not normally possible for a user to communicate with another user using similar but different protocols. In the absence of means for connecting different protocols, two users who wish to communicate must select a protocol they have in common in order to communicate, even though they may already be using the same communication network or interconnected networks. When, as is often the case, the selected protocol requires the use of a particular device, each user needs to have access to that type of device and be able to use it. This limits the options for communication. Often, no communication can occur, or else the choice of a preferred protocol is compromised by the protocols and devices available.

The multiplicity of protocols in use means that users commonly need to remember a number of contact addresses for each user they want to communicate with, and a user who wants to communicate with another user may be forced to engage in a process of guessing which address/protocol pair may be the appropriate option at a given time and trying one address/protocol pair after another.

There are known methods and devices for connecting different protocols. One method is to use a bespoke (made-to-order) adaptor that connects a specific pair of protocols. Examples of adaptors are shown in U.S. Pat. Nos. 6,020,980 and 6,625,642. These adaptors take those features of each protocol that can be mapped to a corresponding feature of the other protocol, and provide a mechanism to create a valid pathway between those corresponding features.

One disadvantage of these bespoke adaptors is that the adaptor is defined by the two protocols being connected and, because addresses are protocol-specific, the output protocol for the recipient, and the address on that output protocol, must be specified before conversion can occur. In order to ensure the output address/protocol pair is specified before conversion occurs, it has been necessary to either require the initiator of the communication to specifically provide the output address/protocol pair, or in some way to build the information into the recipient's address.

As an example of the initiator specifically providing the information, a Short Message Service (SMS) to email adaptor may require the sender to type in the email address of the recipient as the first part of an SMS message sent to the adaptor, to enable the adaptor to deliver the remainder of the SMS message as an email to the email address. As an example of building the information into the recipient's address, an email to SMS adaptor may require a special email address be allocated to a cellular phone user, so that text sent as an email to this special email address is delivered to the adaptor for processing and forwarding (possibly dependent on the application of certain rules) to the recipient's cellular phone in the form of one or more SMS messages.

A further disadvantage of known bespoke adaptors is that, since they map common features and disregard those features which are not common to both, they typically remove capabilities. This can lead to communication problems and loss of information, for example when the output protocol does not support long messages or attachments, whereas the input protocol does. In order to avoid this loss of information, some adaptors store a received communication which cannot be converted without loss of information, and then advise the intended recipient, using the recipient's protocol, that the complete communication can be collected by the recipient using a third protocol.

As an example of this approach, a user with a cellular phone which supports Multimedia Messaging Service (MMS) might attempt to send an MMS message containing a photograph to another cellular phone which does not support MMS, but does support SMS. The MMS centre responsible for delivering the message to the recipient may store the MMS message on a website and send an SMS text message to the intended recipient advising that the MMS message can be viewed if the recipient connects to the Internet and accesses the website using a web browser (which uses HTTP protocol). Although this doesn't actually lose information, all that is delivered is a notice of failure of delivery. Delivery of the complete communication itself is uncertain, as it may not be collected by the recipient.

Another known method of connecting different protocols uses a common intermediate protocol. This enables a number of protocols to be connected whilst avoiding the need to create a new bespoke adaptor for each pair of protocols to be connected, which is a resource-intensive process. However, the output protocol for the recipient, and the address on that output protocol, must still be specified before conversion can occur.

There are also known methods for unified messaging which enable communication messages to be retrieved using a protocol different to that of the received message. An example of a unified messaging apparatus is shown in U.S. Pat. No. 6,711,154. These common intermediate protocol and unified messaging methods do not provide for dynamic routing and protocol conversion of communications.

There are also some methods which provide limited dynamic routing and protocol conversion of communications based on recipient preferences for routing of communications and/or availability of recipient communication devices. These methods typically are aimed at routing communications to a recipient who may be away from normal fixed communication devices. Examples are shown in U.S. Pat. Nos. 6,606,647 and 5,742,905. A disadvantage of these methods is that only the preferences of the recipient are taken into account. These methods typically have other limitations such as requiring the use of a special recipient address, and/or requiring the use of a client device, such as a personal computer or wireless personal digital assistant, running specific client software and in communication with a central server, to obtain benefits in terms of dynamic routing.

A disadvantage common to all of these known methods is that there is no opportunity for negotiation of a communication protocol that would best match the needs of both initiator and recipient.

It is an aim of the present invention to provide a method and apparatus for routing communications, in which at least some of the above problems of predetermined output protocol and the address on that protocol, and other limitations inherent in known methods for connecting different protocols, are substantially overcome or ameliorated, to thereby provide a more effective communication system for users.

### SUMMARY OF THE INVENTION

In one broad form, the invention provides a method for routing a communication, such as a telephonic or data communication, between an initiator and a recipient based on preferences of the initiator and the recipient, the method including the steps of

storing a plurality of end-points for a user as a virtual end-point for that user, where the user may be an initiator or recipent of the communication, each end-point being a representation of the source and/or destination of a communication from or to the respective user,

associating preferences with each virtual end-point, the preferences specifying which end-point from the plurality of end-points of the respective virtual end-point to use for a routing path for a communication when certain criteria are met, and

determining a routing path between an initiator end-point and a recipient end-point in accordance with the preferences associated with the virtual end-points for the recipient and the initiator.

In another form, the invention provides apparatus for routing a communication, such as a telephonic or data communication, between an initiator and a recipient based on preferences of the initiator and the recipient, the apparatus including

storage means for storing a plurality of end-points for a user as a virtual end-point for that user, where the user may be an initiator or recipent of the communication, each end-point being a representation of the source and/or destination of a communication from or to the respective user, and data relating to preferences associated with each virtual end-point, and

means for determining a routing path between an initiator end-point and a recipient end-point in accordance with the preferences associated with the virtual end-point for the recipient and the initiator.

Once a routing path is determined, communication can be established between the initiator (or initiating) end-point and the recipient (or receiving) end-point via the determined routing path.

If the recipient end-point has a different communication protocol and/or format from that of the initiator end-point, the protocol and/or format of the communication is converted from that of the initiator's end-point to that of the recipient's end-point. This may include first converting the protocol and/or format of the initiator's end-point to an intermediate protocol, and then to that of the recipient's end-point.

In a preferred embodiment of the invention, a negotiation gateway is connected to one or more communication networks. The negotiation gateway has means for storing associations of data using a data store. Associations of end-points are stored in the data store as virtual end-points. Each virtual end-point is a collection of end-points for a user, where a user is an initiator or recipient of communications. An end-point is a representation of the source and/or destination of a communication and is typically an address/protocol pair such as a telephone number or an email address. Each virtual end-point is associated with preferences, where the preferences specify which end-point from the association of end-points to use for a routing path when certain criteria are met.

The gateway has means for receiving and for transmitting communications. A received communication may be addressed to the gateway (eg a request for an action), otherwise it is a communication to be delivered by the gateway. A request to the gateway may be for a routing path or be some other request, and the results of the request may optionally be returned to the end-point from which the request was received.

When a communication is received by the gateway, the gateway identifies one or more initiating end-points (which may be implied) and one or more receiving end-points, [the ‘identified’ end-points]. End-points may be defined by the communication (ie, they are the ‘from’ and ‘to’ addresses of the communication) or designated within the communication (eg as meta-data). An end-point may comprise an identifier for a virtual end-point.

The received communication may contain text, image, audio, video, digital data of any type, or any combination of these, encoded in one or more formats according to one or more protocols. Each received communication is converted into a common intermediate protocol.

When the received communication is not addressed to the gateway, or is a request for a routing path, the gateway proceeds to determine a routing path. The gateway then identifies, for each identified end-point, zero or one virtual end-point. A virtual end-point may not be identified for a particular end-point because one cannot be found, or because the gateway has determined that no virtual end-point is required for that end-point (eg because that end-point is not relevant to the routing path). For each identified virtual end-point, the gateway retrieves associated preferences.

Retrieved preferences can include criteria with respect to: other virtual end-points and/or end-points; types of communication including protocols and formats; and dynamic data. The preferences include a structured ordering of categorisations of end-points. Dynamic data may be retrieved for each virtual end-point or end-point, and typically comprises information relevant to the determination of a routing path, such as end-point status from a communication network.

A routing path is determined as a function of the retrieved preferences, retrieved dynamic data, and identified end-points. The end-points in the identified preferences with best matching categorisations are chosen for inclusion in the routing path. (This may be best match by category, or best match within the best matching category, or best matching end-point within the best matching category.)

Preferably, the routing path is determined by a rules engine using rules-based processing.

If the received communication is a request for a routing path, the routing path is returned, typically to the end-point from which the request was received. If the communication is to be delivered by the gateway, it is converted to the protocol of the destination end-point in the routing path and transmitted to the communication network associated with that destination end-point.

Advantageously, the determined routing path is cached. Subsequent communications that match an existing cache entry are routed directly in accordance with data in that cache entry, with no further retrieval or processing of data required.

The received communication may contain multiple recipient end-points, in which case multiple routing paths are determined, one for each combination of initiating end-point and receiving end-point (i.e. the communication is “multi-cast”).

Multiple routing paths may also be determined for a single receiving virtual end-point, and all or part of the communication, dependent on the retrieved preferences, may be delivered according to each of the determined routing paths.

The received communication may comprise a request from a user for an action to be performed by the gateway. For example, the request may be for a change to a user's stored virtual end-point or preferences.

In another embodiment, two or more gateways are interconnected by an appropriate communication network such that data can be exchanged. Preferably, the steps of retrieval of preferences and data include suitable processing to maintain the privacy of the data.

In another embodiment, the gateway determines routing paths for communications in a single protocol.

In a modified form of the invention, a routing path between an initiator end-point and a recipient end-point is determined in accordance with the preferences associated with the virtual end-point for the initiator only. For example, the recipient may have multiple end-points, and a recipient end-point is selected in accordance with the preferences associated with the virtual end-point for the initiator.

As the present invention provides a method for dynamically determining a routing path as a function of preferences associated with the initiator, or the initiator and recipient, it is not necessary for the recipient's output protocol, and the address on that output protocol, to be specified (for example, by the initiator including it as part of the message, or by building it in to the recipient's address) to enable protocol conversion to occur. Compared to the prior art, the choices of communication protocol, and hence device, available to the initiator can be substantially increased, whilst both the number of contact addresses the initiator must remember, and the need to engage in a process of guessing and trying address/protocol pairs, can be substantially reduced.

Other advantages of the present invention include:
a Routing decisions can be produced that better match the preferences of both initiator and recipient and which provide users with better and more consistent control over communication. For example, a recipients preferences could specify that received text messages are processed such that messages from some users are routed to the recipient's cellular phone, those from other users are routed to email, and those from yet others are deleted. Since preferences can be determined as a function of user, a recipient could also specify, for example, that no communication from a particular user is delivered.
b Since specification of the destination address/protocol pair by the initiator is not necessary, recipients have more flexibility in terms of giving out address/protocol pairs to other users, and therefore more control with respect to privacy.
c A routing path can be determined dynamically, independent of the delivery of the actual communication, thereby allowing otherwise incompatable systems to enjoy the benefits of a dynamically determined routing path. For example, in preferred embodiments of the present invention, telephone, postal or courier systems may participate in a system that enables a voicemail to be delivered as email, an electronic message to be printed and delivered by post, or a parcel to be delivered in accordance with a dynamically determined routing path. This is an improvement over prior art methods in which the system that determines the routing path usually must also carry the communication.
d Since communications are routed dynamically, if the routing path is cached, a change in a user's preferences will take effect immediately, meaning that details of an end-point can be changed without breaking the connection. For example, a user could switch communication device or protocol mid-conversation.
e If rules-based processing is used within the routing logic, user-specified actions may be performed, based on preferences and rules for initiator and/or recipient.
f If a common intermediate protocol is used, processing such as data encryption, compression or auditing may be applied uniformly to all processed communications. This is an improvement over prior art methods in which protocols are handled separately, and conversion for each protocol pair is handled separately, providing no central location for such logic.
g A communication may be divided into several parts which are delivered to separate end-points. This is an improvement over storing all or part of the communication for collection, or simply not delivering some parts at all. For example, a user could send an urgent email with an attached document which could be divided into two parts, as specified in the recipient's preferences, resulting in the text of the email being delivered to the recipient's urgent text device (eg their cellular phone) and the attachment being delivered to the recipient's work email address.

To assist in understanding and implementing the present invention, embodiments thereof will now be described, by way of example, with reference to the accompanying drawings in which like numerals indicate like elements.

### BRIEF DESCRIPTION OF THE DRAWINGS

FIG. 1 is a block diagram of a gateway in accordance with one embodiment of the present invention, connected to two communication networks which are used by two communication users.

FIG. 2 is a flowchart illustrating logic executed by the gateway of FIG. 1 for determining a routing path.

FIG. 3 is an example of two virtual end-points which are used to describe the logic of FIG. 2.

FIG. 4 is a flowchart illustrating logic executed by the gateway of FIG. 1 for storing and retrieving a cached entry containing details of a dynamically determined routing path.

FIG. 5 is a block diagram of two interconnected gateways in accordance with another embodiment of the present invention, each executing logic illustrated in FIG. 2, FIG. 3, and FIG. 4, and each connected to a respective one of two communication networks, each of which is used by a respective one of two users.

### DETAILED DESCRIPTION OF EMBODIMENTS OF INVENTION

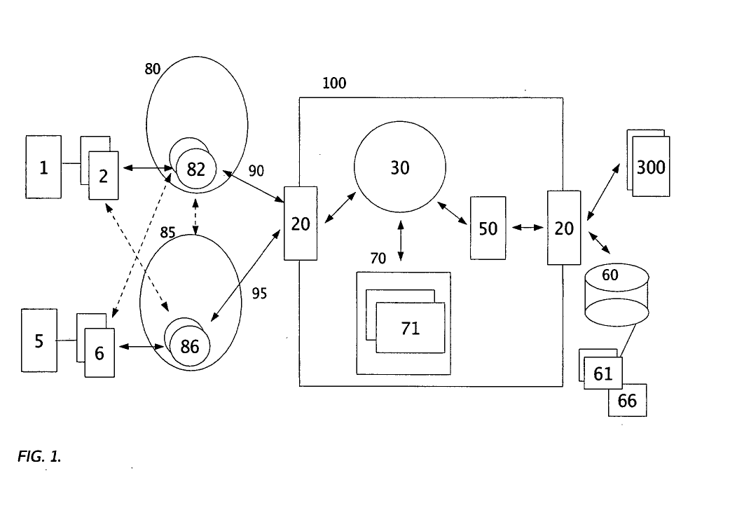

Referring to FIG. 1, users 1 and 5 are each a person, computer program, an executing piece of computer logic, or any other agent capable of sending and/or receiving information. Users 1 and 5 can each use a plurality of communication devices including 2 and 6, respectively. Devices 2 and 6 are connected to networks 80 and 85, respectively, and may each be a physical device such as a telephone, cellular phone or pager, or a non-physical device, including software such as an email or instant messenger client or server, etc.

Networks 80 and 85 are connected to gateway 100, and can be any type of network that can interface by electronic means and transport communications according to one or more protocols, such as telephone networks (eg PSTN or cellular), and data networks (eg, LAN, WAN, and the Internet). As shown by dashed lines, devices for users 1 and 5 may be connected to different networks, and networks 80 and 85 may or may not be interconnected.

Communication channels to devices on a network are represented as end-points within that network. End-points 82 and 86 represent channels to devices 2 and 6, respectively, and are each identified by a communication address/protocol pair, such as a telephone number, pager number, email address, etc. It should be noted that a single device may be represented by multiple end-points, and that these end points may be on different networks, eg a cellular phone may be represented by a telephone number and an email address.

Data flow between elements are illustrated using lines with arrows. Communications between gateway 100 and end-points 82 and 86 are formatted in protocols 90 and 95, respectively. Communications between gateway 100 and further end-points on networks 80 and 85 may be formatted in protocols other than protocols 90 and 95.

Gateway 100 includes communication ports 20, data interface 50, cache 70 (which is optional), and routing engine 30.

Communication ports 20 are used to connect gateway 100 to external components such as networks 80 and 85, external systems 300 (which are optional), and data store 60, and references in this document to gateway 100 communicating with such external components, implictly refer to using communication ports 20 for such communication. Communication ports are known in the art, and include ethernet ports, USB ports, and serial ports, etc.

Routing engine 30 and data interface 50 each implement logic that may be embodied in one or more computer programs, in machine code for a programmable microprocessor, or in electronic circuitry such as one or more integrated circuits, which are all known in the art. Advantageously, new definitions and logic may be added in the form of plug-in modules, to provide support for a new protocol or external system 300. In all cases, the logic may run in a single execution unit, or simultaneously in multiple execution units. In addition, multiple gateway devices may be clustered together to effect a single, parallel-processing gateway 100.

Data interface 50 is used to send and retrieve information to and from other components such as data store 60, and zero or more external systems 300. The logic of data interface 50 responds to requests for information by identifying the source of the requested information (eg, data store 60, or one of external systems 300), formatting the request into a protocol appropriate to that source, and then formatting the response into the protocol appropriate for the requestor, e.g. routing engine 30 or one of external systems 300.

In preferred embodiments of the invention, the logic of data interface 50 uses mechanisms known in the art, such as a hashtable or dictionary lookup to identify the source for a request, and protocol converters.

Data store 60 contains data, including virtual end-points 61 and 66, and is capable of retrieving a virtual end-point using an associated identifier. Such an identifier may be regarded as a virtual end-point “address”.

Data store 60 may be implemented using software known in the art such as indexed files or a database, or using other computer programs, machine code, or electronic circuitry such as one or more integrated circuits, to manage non-volatile electronic storage such as Random Access Memory, disk or tape. In some embodiments, data store 60 is contained fully or partially within gateway 100.

Virtual end-points 61 and 66 are each stored representations of associations of end-points, for example the association of communication addresses (eg cellular phone number, pager number and/or email address) for a user. Virtual end-point 61 comprises data representing all known end-points for user 1, and virtual end-point 66 comprises data representing all known end-points for user 5.

The external systems 300 provide information on request. One example of an external system is a network, which may provide dynamic data on the current status of an end-point. Each external system defines the protocol or protocols in which it receives requests.

Cache 70 contains temporary entries such as virtual connection 71, which are stored there and retrieved by routing engine 30. Cache 70 may be implemented using techniques known in the art including electronic circuitry such as one or more integrated circuits, or computer memory, such as Random Access Memory (RAM). Some or all of the logic for managing cache 70 may be implemented in the logic of routing engine 30. Advantageously, a battery backup may be used to preserve the contents of cache 70 in the event of power failure.

Routing engine 30 implements logic that determines routing paths between end-points as a function of preferences associated with those end-points, as explained below.

When a communication is received by gateway 100, routing engine 30 retrieves information from the communication, in order to complete the processing of the communication. In general, routing engine 30 ignores any communication from which it cannot retrieve the information required to process that communication, and hence gateway 100 will ignore any communication which is in a protocol for which the gateway has not been configured. Advantageously, gateway 100 can be configured for individual protocols using plug-in logic modules.

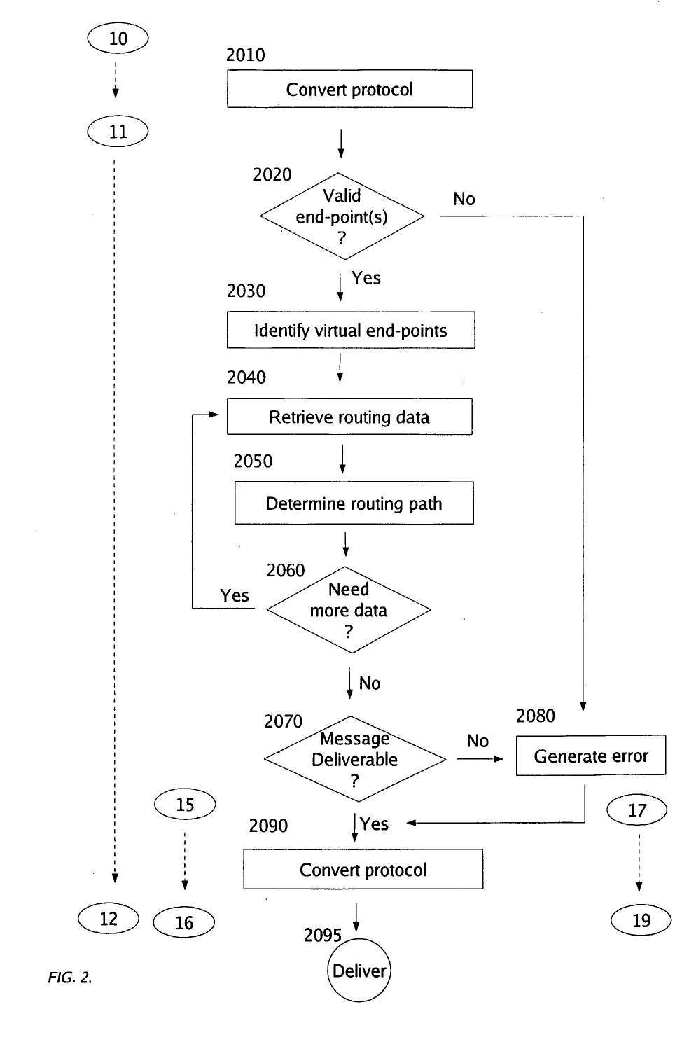

A communication may be addressed to gateway 100, in which case it is processed as a request for an action and the results are optionally returned to the end-point from which the request was received. The request may be for the determination of a routing path and/or for the transmission of a communication. If a received communication is a request for some other action (eg a request to modify a virtual end-point) then the gateway performs that action in a fashion not described in this specification. If a received communication is not addressed to gateway 100, or contains a request for the determination of a routing path, then the gateway uses the logic illustrated in FIG. 2 to determine a routing path.

Additionally, preferred embodiments can dynamically convert and deliver communications in accordance with determined routing paths. In these preferred embodiments, routing engine 30 uses one or more protocol converters to convert a communication from one protocol to another. Protocol converters are known in the art and, in preferred embodiments, are implemented as plug-in logic modules. Advantageously, each protocol converter converts between one or more external protocols and a common intermediate protocol.

In one example, a communication initiated by user 1, using device 2 and destined for user 5, is transmitted via network 80, which forwards it to gateway 100. Routing engine 30 dynamically determines a routing path from end-point 82 to end-point 86, as explained in detail below, and forwards the communication to end-point 86, resulting in network 85 delivering the communication to device 6, for user 5.

In another example, a communication is initiated by user 1, using device 2 and destined for user 5. In response, network 80 initiates a further communication to gateway 100, requesting a suitable routing path between users 1 and 5. Routing engine 30 dynamically determines a routing path between end-points 82 and 86 which is returned to network 80. Network 80 then forwards the communication to network 85, to which it is connected, in accordance with the routing path, and network 85 delivers the communication to device 6, for user 5. It will be understood that network 80 could establish a connection to network 85 based on the routing path determined by gateway 100, such that further communication associated with this connection is transported by the networks automatically in accordance with the connection.

It will be further understood that networks 80 and 85 need not be electronic networks, provided they can interface to gateway 100. For example, a postal or courier network could use one or more electronic devices (eg computers or computer terminals, bar-code readers, printers, etc.) to interface to gateway 100, and request determined routing paths for delivery of non-electronic communications such as letters or parcels.

FIG. 2 is a flowchart illustrating logic executed in routing engine 30 to determine a routing path for a communication. An example illustrates the dynamic determination of a routing path for a communication, and the conversion and delivery of the communication. It will be understood that similar logic may be used for communications for which protocol conversion and/or delivery is not required. The logic begins at block 2010 with routing engine receiving communication 10, and converting the protocol of communication 10 to a common intermediate protocol, producing communication 11. The routing engine includes all data on initiating and receiving end-points as meta-data in communication 11. Such data includes the initiating and receiving end-point implicit in communication 10, as well as any virtual end-point addresses and end-points designated within message 10 for use in determining the routing path. Virtual end-point addresses are identifiers for a virtual end-point, and typically comprise numbers or text strings, as defined by the embodiment of the invention in which they are used.

If (at block 2020) routing engine 30 cannot identify any receiving end-point for communication 10, then it is deemed undeliverable and the routing engine proceeds to block 2080. In certain preferred embodiments of the invention, the routing engine generates (at block 2080) error message 17 which is converted (at block 2090) to the protocol of the initiator producing communication 19, which is then delivered to the initiator. In further preferred embodiments, if routing engine 30 cannot identify an initiating end-point, then communication 10 is deemed undeliverable and discarded.

Routing engine 30 looks (at block 2030) in the meta-data of communication 11 for an initiating and a receiving virtual end-point address. For each virtual end-point address not found, routing engine 30 provides the corresponding designated end-point or, failing that, the corresponding implicit end-point of communication 10, to data interface 50 and requests the virtual end-point address. Data interface 50 may retrieve the requested information from data store 60. It will be understood that zero, one or two virtual end-point addresses will be retrieved and that, in the case where no virtual end-point addresses are retrieved, the method is trivially reduced to routing between two end-points.

Routing engine 30 retrieves (at block 2040) data for determining the routing path by querying external data interface 50 which then retrieves the information from data store 60 and/or one or more external systems 300. Initially, the data requested includes at least the preferences for each virtual end-point that apply to communications involving the other end-point or virtual end-point. Further information may also be requested, including further preferences, and dynamic data such as the status of various end-points, time of day, etc.

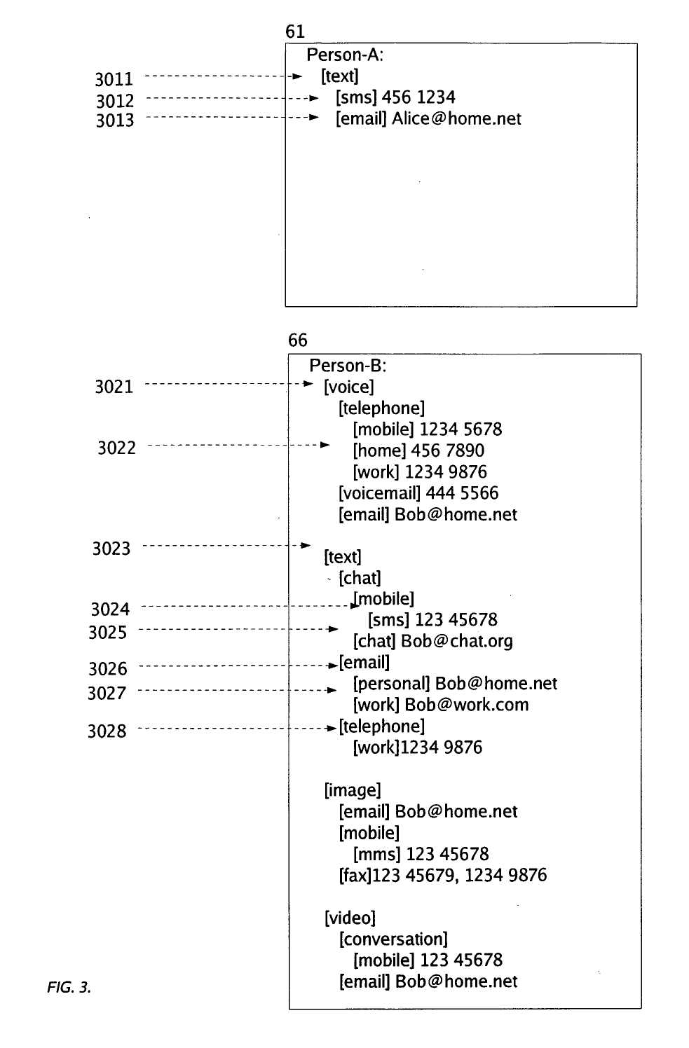

Routing engine 30 then determines (at block 2050) a routing path for communication 11 as a function of the data retrieved at block 2040. The determined routing path comprises a vector of end-points including at least one destination end-point. The end-points for the routing path are determined by finding the end-points in the preferences with the best matched criteria, as described with reference to FIG. 3.

If routing engine 30 requires (at block 2060) more data to determine the best match, then the logic proceeds back to block 2040. For example, the routing engine could choose from a list of possible routing paths by proceeding to block 2040 to retrieve information on which routing paths in that list contain destination end-points that are currently “available”.

If no further data is required, routing engine 30 determines (at block 2070) whether communication 11 can be delivered according to the routing path. One possible reason for the communication being undeliverable is that the retrieved preferences indicate that delivery should not occur and the routing path has been set to indicate this. If delivery is not possible, then the logic proceeds to block 2080.

If the communication is deliverable, then routing engine 30 converts (at block 2090) communication 11 into the protocol associated with the destination end-point of the routing path, producing communication 12 which is then delivered.

Routing engine 30 may retrieve (at block 2030) multiple receiving end-points and/or receiving virtual end-points (ie, the communication is “multi-cast”). In this case, multiple routing paths are determined, one for each combination of initiating end-point or virtual end-point, and receiving end-point or virtual end-point.

Routing engine 30 may determine (at block 2050) multiple routing paths for a single receiving virtual end-point. In this case, all or part of communication 11 is delivered according to each of the multiple routing paths. For example, a user's preferences may cause a fax received for any fax end-point to be delivered to multiple fax end-points. Communications may be split into multiple parts along easily identifiable boundaries, such as those between messages and attachments, or messages and headers, or along arbitrary boundaries, such as at the 10^{th} line of text or at the 30^{th} second of audio. For example an email with an attachment may be delivered to multiple end-points such that the message is delivered to a cellular phone, the attachment is delivered to one email address, and the entire email is delivered to a different email address.

In certain embodiments, routing engine 30 may send a notification of success to the initiator, by creating success notification 15 and (at block 2090) converting it to the protocol of communication 10, producing communication 16, which is delivered to the initiator of communication 10.

In a further example, communication 10 is a request for a determination of a routing path. In this case, communication 10 is addressed to gateway 100, and includes identifiers of the designated end-points or virtual end-points for the requested routing path. Routing engine 30 determines the routing path for the designated end-points or virtual end-points, and delivers the determined routing path to the initiator of communication 10. Routing engine 30 may dynamically determine the initiating end-point of a routing path. For example user 1 could request a routing path to user 5, specifying a category of protocol (eg text) instead of a particular protocol (eg SMTP). Routing engine 30 would then determine the end-points of the routing path to best match both users' preferences regarding that category of protocol. It will be understood that other embodiments may include virtual end-points for initiators only, and determine routing paths as a function of the preferences associated with the virtual end-point for the initiator.

Further types of request are also possible, such as requests by users for some other action to be performed by gateway 100. For example, a user may request that changes be made to the user's virtual end-point, which will be processed by the gateway in fashion not described in this specification.

It will be understood that requests to gateway 100 may be in any protocol understood by gateway 100, and therefore users could initiate requests using, for example, SMS, email, instant message, HTTP, etc.

FIG. 3 illustrates an example of two virtual end-points, 61 and 66, for user 1 (Person-A) and user 5 (Person-B), respectively. The rows of information in each virtual end-point form a structured list. Any two rows indented the same distance from the left margin are at the same level in the structure. A first row is considered to contain a second row if the first row is above and indented less than the second, and there are no intervening rows that are indented the same or less than the first. For example, row 3012 is inside row 3011, which indicates that row 3011 is a more general category containing row 3012. In this way end-points are catergorised into groupings of protocols, where the more general categories (e.g. rows 3011, 3021, 3023, etc.) represent, in effect, virtual protocols. Matches of preferences of the initiator and recipient can therefore be performed at the virtual protocol level, (e.g. Person-A/text) rather than only at the physical protocol level (e.g. alice@home.net).

In an example of the application of the invention, a text message is sent using an SMS protocol by Person-A to Person-B. In this example, Person-A does not know the address of any text-capable device for Person-B, so addresses the message to Person-B's home telephone number. As depicted in the logic flowchart of FIG. 2, routing engine 30 converts the message into a common intermediate protocol, determines the virtual end-points for Person-A and Person-B, and retrieves the preferences for Person-B regarding communications from Person-A, and the preferences for Person-A regarding communications to Person-B. In this example, the preferences retrieved are as shown in FIG. 3, and could be a combination of default values and specific rules regarding Person-A and Person-B.

To determine the routing path, routing engine 30 first looks for a match between the initiating end-point (represented by row 3012) and the receiving end-point (represented by row 3022). Since the categories of row 3012 (SMS, text) do not match any of the categories of row 3022 (home, telephone, voice), these rows (and hence their end-points) are not protocol-compatible. Routing engine 30 therefore finds the most specific category of row 3012 that matches the most specific category of Person-B's preferences, this match being rows 3012 and 3024. The routing engine then retrieves information from data interface 50 to determine if the end-point of row 3024 is currently available. If that end-point is not currently available, then the next more general match is considered, in this case rows 3012 and 3025, followed by 3012 and 3026, 3012 and 3027, then 3012 and 3028. The first of these matches associated with a currently available end-point is selected as the routing path.

It will be understood that protocols 90 and 95 need not be similar. For example, a text-to-voice converter would be used to convert communication 11 into an audio-encoded communication 12 if the SMS were routed to row 3028. It will also be understood that if Person-A sends an SMS to Person-B's work telephone number, it will be converted and delivered directly, since Person-A's and Person-B's preferences make rows 3012 and 3028 protocol-compatable.

It will be understood that matching the preferences for both initiator and recipient by category produces a set of possible routing paths that is the arithmetic product of the number of end-points in each virtual end-point that match by category. This can result in a larger set of possible routing paths than when using a single virtual end-point, or when matching by physical protocol only. In this example, the total set of possible routing paths for the text category is 10 (2 for Person-A multiplied by 5 for Person-B). In contrast, there is only a single SMS match between the two virtual end-points (rows 3012 and 3024), and only four physical recipient end-points that would conventionally be considered compatible with an SMS (rows 3024, 3025, 3026, 3027).

Preferred embodiments of the present invention may implement variations on the logic described here. For example, instead of choosing the first routing path with an available end-point, a weighted decision could be made that selects a path with an unavailable end-point that is a better category match, and has store-and-forward capabilities, in preference to one with an available end-point that is a worse category match. Other preferred embodiments use rules-based processing to implement or enhance the logic. For example, rules could be added to the preferences for Person-B regarding working hours and communications delivered during those hours. The rules-based processing could also allow actions to be triggered by certain criteria. For example, a rule could cause an SMS alert to be generated whenever an email with a large attachment is received from a certain user. Rules-based processing is known in the art, and it will be understood that the illustrated preferences can be translated into rules.

Suitable logic or software can be provided to ensure the security of users' data, such as the virtual end-points, and to restrict certain actions to authorised users, devices, or end-points.

It will be understood that further embodiments of the present invention may implement further logic in the decision process, which may include further data from external systems 300, to enable further types of preferences such as:
how much either user is prepared to pay for this communication;
whether the users jointly want to complete the communication as requested, or would prefer to complete it in another way (eg changing a request for a real-time connection, to a request for a connection to a message queue);
whether the users jointly want the communication to be completed at all (eg a user is busy, away, not available);
classifying the communication for the purposes of storage and billing (eg whether this a business or personal connection).

It will be understood that through this logic, a user is addressable on any available protocol, using any address within the user's virtual end-point. In addition, the address of the virtual end-point can be used as a global protocol-independent address. This may be implemented by mapping addresses on existing protocols to the virtual end-point address, or modifying communications devices to directly address the virtual end-point. Moreover, further virtual addresses can be included in a virtual end-point. For example, one or more role-based identities, such as sales-person@company.com or secretary@club.org, could be included in a virtual end-point to enable role-based routing. A user can therefore control the degree to which they can be contacted when giving a contact address to a second user, by choosing an appropriately controlled address.

It will also be understood that in certain embodiments, routing engine 30 may interface with further external systems 300 using data interface 50 so that transactional information such as billing, logging or auditing, etc. regarding the communications being routed, could be sent and/or received. This enables information being generated within routing engine 30 to be shared with external systems 300.

Additional features may be added to the processing of communications in the common intermediate protocol. For example, the logic of routing engine 30 can be enhanced to apply security checks, compression, encryption, etc. Any such processing can be made available for any communication that is handled by routing engine 30, regardless of the protocol of the received communication, or the protocol of the transmitted communication, as long as that action can reasonably be applied to that type of communication.

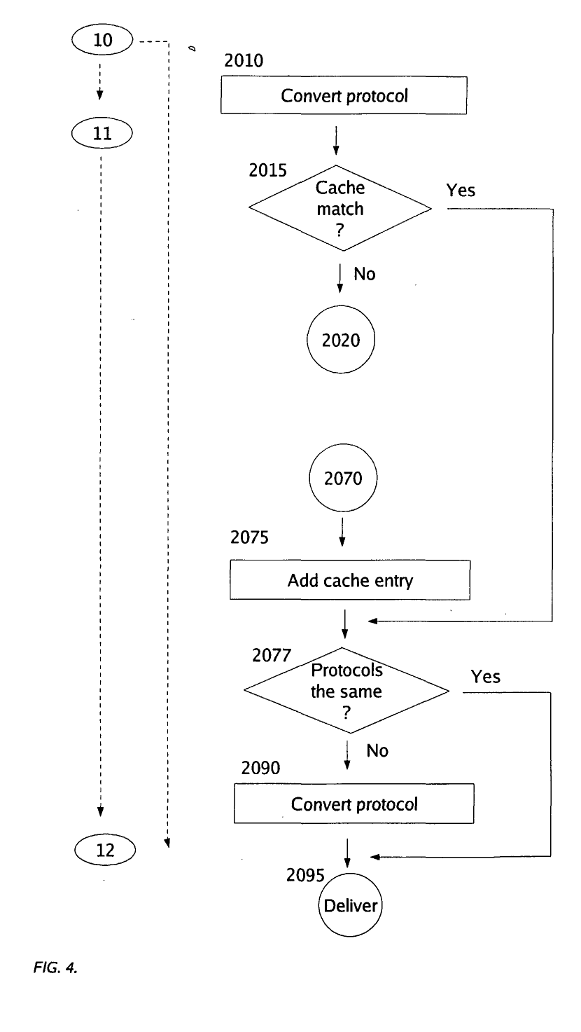

FIG. 4 illustrates additional logic in which routing engine 30 maintains a cache of previously determined routing paths. An example illustrates the dynamic determination of a routing path for a communication, and the conversion and delivery of the communication. The protocol of incoming communication 10 is converted to the common intermediate protocol at block 2010, producing communication 11. Routing engine 30 then looks (at block 2015) for an entry in cache 70, using as the lookup criteria, information within communication 11 such as the initiating and receiving end-points. If the routing engine finds a matching entry for communication 11, then the logic proceeds to block 2077.

If no matching entry is found in the cache, then the logic proceeds to block 2020, and continues, as illustrated in FIG. 2, through to block 2070. If routing engine 30 determines (at block 2070) that communication 11 is deliverable, then the routing engine adds (at block 2075 in FIG. 4) an entry in cache 70 storing the routing path for communication 11 therein. This cached routing path represents a virtual connection between the end-points (shown as virtual connection 71 in FIG. 1).

If routing engine 30 determines (at block 2077) that the destination protocol is the same as that of communication 10, then communication 10 is delivered directly. If the protocols are different, then the routing engine converts (at block 2090) the protocol of communication 11 into the destination protocol producing communication 12, which is then delivered.

It will be understood that once virtual connection 71 has been created, communications can be routed between end-points 82 and 86, the routing paths being determined using the information stored within virtual connection 71, thereby reducing processing time.

It will also be understood that any of the components, end-point 82, end-point 86, protocol 90, or protocol 95, can be changed without disrupting the connection between them, which is independently defined by virtual connection 71. For example, a request for change of end-point could be sent from end-point 82, or some other end-point authorised by user 1, to routing engine 30. Routing engine 30 would process the request using logic including that illustrated in FIG. 4, and as a result, modify virtual connection 71 as specified in the preferences for virtual end-point 61. Subsequent communications received by routing engine 30 and associated with virtual connection 71 would then be delivered in accordance with the modified routing path. Virtual connection 71 may also be deleted from cache 70 in response to a request for an action. For example, when a connection established in accordance with a dynamically determined routing path is disconnected, a network responsible for that connection may request that the corresponding virtual connection in cache 70 is deleted.

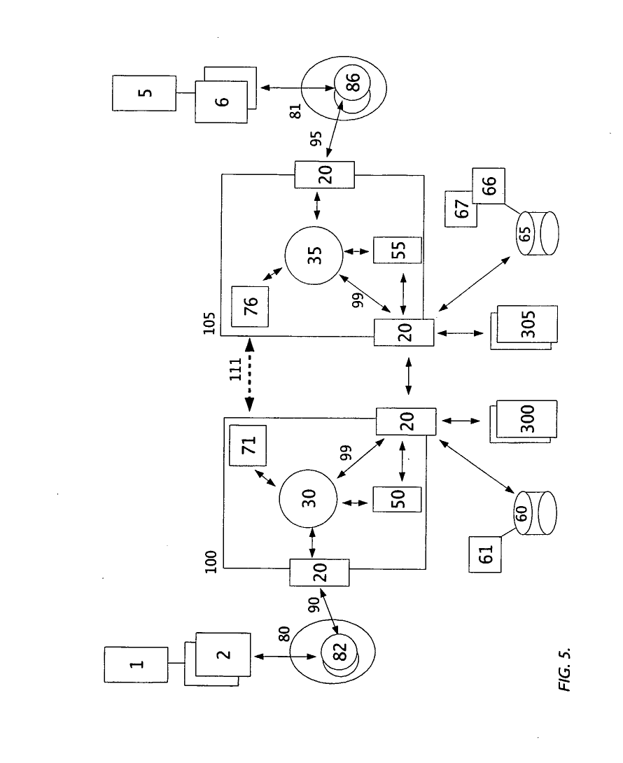

FIG. 5 illustrates two separate, interconnected gateways 100 and 105 according to a further embodiment of the present invention. User 1 uses device 2 which is represented by end-point 82, and is connected via network 80 to gateway 100. User 5 uses device 6 which is represented by end-point 86, and connected via network 85 to gateway 105. The components of gateway 100 are as illustrated in FIG. 1. Routing engine 35, data interface 55, data store 65, and external systems 305, are the corresponding routing engine, data interface, data store, and external systems of gateway 105. Gateway 105 also includes communication ports 20. Virtual end-point 61 represents user 1, virtual end-point 66 represents user 5, and virtual end-point 67 represents routing engine 35. Protocol 99 is the common intermediate protocol.

In one example, a request for a routing path in the form of communication 10 is sent by user 1 using end-point 82, to an end-point associated with user 5. In this example, communication 10 is a connection request, such as a request for an instant message (“chat”) session, and contains both a message to be delivered, and a request for a routing path. As described above with reference to the routing logic of FIGS. 2 and 4, routing engine 30 converts (at block 2010) communication 10 to communication 11. Routing engine 30 identifies (at block 2030) the virtual end-point addresses for the initiator and recipient using data interface 50. In this example, data interface 50 retrieves the virtual end-point 61 for user 1 from data store 60, but finds no information for user 5 in data store 60. Data interface 50 then queries a global user-to-system server, which is one of the external systems 300, which returns the address of routing engine 35. Data interface 50 returns this address to routing engine 30 as the receiving virtual end-point for communication 11. (Preferably, the global user-to-system server is implemented using logic which is known in the art, for example that of DNS or LDAP servers.)

Routing engine 30 retrieves (at block 2040) the data pertaining to each virtual end-point. Data interface 50 retrieves the data for virtual end-point 61 from data store 60, and data for virtual end-point 67 via data interface 55. From the data retrieved for virtual end-point 67, routing engine 30 determines (at block 2050) the destination end-point of the routing path to be routing engine 35 and protocol 99. Routing engine 30 stores (at block 2075) this routing path in virtual connection 71.

Routing engine 30 delivers (at block 2090) communication 11 to routing engine 35 using the common intermediate protocol 99. Since the delivery protocol is the same as that of communication 11, no conversion need actually take place.

Routing engine 35 also implements the logic illustrated in FIGS. 2 and 4. Routing engine 35 (at block 2010) normally converts the communication to the common intermediate protocol, producing communication 11. However, since routing engine 30 sent the communication in the common intermediate protocol, no conversion need actually take place.

Routing engine 35 (at block 2030) identifies the designated virtual end-point addresses for both the initiator and recipient of communication 11 using data interface 55 which locates virtual end-point 66 in data store 65. Preferably, routing engine 30 includes the address of virtual end-point 61 as meta-data in communication 11. However, it will be understood that routing engine 35 can also identify the initiator's virtual end-point using data interface 55 and external systems 305.

Routing engine 35 (at block 2040) retrieves data pertaining to virtual end-points 61 and 66 by querying data interface 55. Data interface 55 retrieves preferences for virtual end-point 61 via data interface 50, and preferences for virtual end-point 66 from data store 65.

Routing engine 35 also determines (at block 2050) from the retrieved preferences, the preferences of user 1 regarding connections to user 5, and the preferences of user 5 regarding connection requests from user 1, and determines that the destination end-point is end-point 86 over protocol 95.

Routing engine 35 creates or modifies (at block 2075) virtual connection 76 to contain a routing path between virtual connection 71 and end-point 86 on protocol 95, and notifies routing engine 30 of the completed connection. Routing engine 30 updates virtual connection 71 to point to virtual connection 76. Routing engine 35 converts (at 2090) communication 11 into protocol 95 producing communication 12 which is delivered to end-point 86.

It will be understood that virtual connections 71 and 76 now define a mapped virtual connection 111 which defines the routing path between end-points 82 and 86, and that the details of end-point 82, protocol 90, end-point 86, or protocol 95 can be changed without disrupting the connection.

However, routing engines 30 and 35 can dynamically route communications between end-points 82 and 86 without creating virtual connections 71 and 76.

In a modified embodiment of the present invention, gateways 100 and 105 share a single virtual connection (71 or 76), which is located abitrarily on a single gateway.

In still another modified embodiment of the present invention, routing engine 35 delivers communication 11 to a further negotiation gateway (ie, end-point 86 is a routing engine in accordance with an embodiment of the present invention). In practice, any number of gateways may be chained together to define a path between an initiator and a recipient.

The present invention enables different communication users using different protocols to connect and communicate seamlessly, without being aware of the details of the device or protocol being used by the other user. In addition, users can experience further benefits such as:
added control resulting from the negotiation of connections in accordance with each user's preferences;
the ability to change device or protocol midway through a conversation; and
the added features which can be automatically applied to all protocols and devices.

The foregoing describes only some embodiments of the invention, and modifications and additions which are obvious to those skilled in the art may be utilised without departing from the scope of the present invention.

For example, instead of the received communication being converted to a common intermediate protocol, it can be stored in a buffer until the routing path is determined, and then converted directly to the protocol of the destination end-point (if that protocol is different from the initiating end-point protocol).

Although the invention has been described with particular reference to determining routing paths between communication end-points, it will be understood that the communication between the end-points can incorporate other information. For example, financial transactions such as monetary transfers, can be routed between dynamically determined financial end-points, such as bank accounts.

1. A method of routing a communication, including a telephonic or data communication, between an initiator and a recipient based on preferences of the initiator and the recipient, the method comprising:
storing a plurality of end-points for a user as a virtual end-point for that user, where the user includes an initiator or a recipient of the communication, each end-point being a representation of the source and/or destination of a communication from or to the respective users;
associating preferences with each virtual end-point, the preferences specifying which end-point from the plurality of end-points of the respective virtual end-point to use for a routing path for a communication when certain criteria are met; and
determining a routing path between an initiator end-point and a recipient end-point in accordance with the preferences associated with the virtual end-points for the recipient and the initiator.

2. A method as claimed in claim 1, wherein the communication has more than one recipient end-point, and a routing path is determined between the initiator end-point and each recipient end-point in accordance with the preferences associated with the virtual end-points for the initiator and the respective recipients.

3. A method as claimed in claim 1, further comprising deriving at least one additional communication from the communication, and determining a routing path between the initiator end-point and a respective recipient end-point for each additional communication.

4. A method of routing a communication, including a telephonic or data communication, between an initiator and a recipient based on preferences of the initiator, the method comprising:
storing a plurality of end-points for the initiator as a virtual end-point for that initiator, each end-point being a representation of the source and/or destination of a communication from or to the initiator;
associating preferences with the initiator's virtual end-point, the preferences specifying which end-point from the plurality of end-points of the initiator's virtual end-point to use for a routing path for a communication when certain criteria are met; and
determining a routing path between an initiator end-point and the recipient end-point in accordance with the preferences associated with the virtual end-point for the initiator.

5. A method as claimed in claim 4, wherein the recipient has multiple end-points and the determining a routing path includes selecting a recipient end-point in accordance with the preferences associated with the virtual end-point for the initiator.

6. A method as claimed in claim 1 or 4, wherein the preferences for a virtual end-point specify the categories to which the end-points of that virtual end-point belong, and the determining a routing path includes determining the best matching end-points by reference to category.

7. A method as claimed in claim 1 or 4, further including enabling communication between the initiator end-point and the recipient end-point via the determined routing path.

8. A method as claimed in claim 1 or 4, wherein the recipient end-point has a different communication protocol and/or format from that of the initiator end-point, and wherein the method further comprises converting the protocol and/or format of the communication from that of the initiator's end-point to that of the recipient's end-point.

9. A method as claimed in claim 8, wherein the converting the protocol and/or format includes converting the protocol and/or format of the communication from that of the initiator's end-point to an intermediate protocol and then to that of the recipient's end-point.

10. A method as claimed in claim 1 or 4, wherein the routing path is determined using rules-based processing.

11. A method as claimed in claim 1 or 4, wherein the determined routing path is stored in cache memory.

12. A method as claimed in claim 1 or 4, wherein each end-point in a virtual end-point is an address/protocol pair.

13. A method as claimed in claim 1 or 4, wherein the preferences for each virtual end-point include one or more of the following:
(i) criteria with respect to other virtual end-points and/or end-points;
(ii) criteria with respect to types of communication including protocols and formats;
(iii) criteria with respect to categories of the end-points; and
(iv) criteria with respect to dynamic data.

14. An apparatus for routing a communication, including a telephonic or data communication, between an initiator and a recipient based on preferences of the initiator and the recipient, the apparatus comprising:
a storage device configured to store a plurality of end-points for a user as a virtual end-point for that user, where the user includes an initiator or a recipient of the communication, each end-point being a representation of the source and/or destination of a communication from or to the respective user, and data relating to preferences associated with each virtual end-point; and
means for determining a routing path between an initiator end-point and a recipient end-point in accordance with the preferences associated with the virtual end-point for the recipient and the initiator.

15. An apparatus for routing a communication, including a telephonic or data communication, between an initiator and a recipient based on preferences of the initiator, the apparatus comprising:
a storage device configured to store a plurality of end-points for the initiator as a virtual end-point for that initiator, each end-point being a representation of the source and/or destination of a communication from or to the initiator, and data relating to preferences associated with the virtual end-point; and
means for determining a routing path between an initiator end-point and a recipient end-point in accordance with the preferences associated with the virtual end-point for the initiator.

16. An apparatus as claimed in claim 14 or 15, wherein said apparatus is connected to one or more communication networks and is adapted to communicate with the initiator end-point and the recipient end-point via the network(s).

17. An apparatus as claimed in claim 14 or 15, further including means for establishing communication between the initiator end-point and the recipient end-point via the determined routing path.

18. An apparatus as claimed in claim 14 or 15, wherein the recipient end-point has a different communication protocol and/or format from that of the initiator end-point, wherein the apparatus further comprises a converter for converting the protocol and/or format of the communication from that of the initiator's end-point to that of the recipient's end-point.

19. An apparatus as claimed in claim 18, wherein the converter converts the protocol and/or format of the communication from that of the initiator's end-point to an intermediate protocol, and then to that of the recipient's end-point.

20. An apparatus as claimed in claim 14 or 15, wherein the means for determining a routing path comprises a rules engine capable of rules-based processing.

21. An Apparatus as claimed in claim 14 or 15, further comprising a cache memory for storing the determined routing path.
